(19) United States
(12) Patent Application Publication
(10) Pub. No.: US 2006/0226832 A1
(43) Pub. Date: Oct. 12, 2006

(54) Detector and detecting method

(76) Inventors: Takashi Ikeda, TOKYO (JP); Satoru Nishiuma, Tokyo (JP); Junta Yamamichi, Tokyo (JP)

Correspondence Address: FITZPATRICK CELLA HARPER & SCINTO, 30 ROCKEFELLER PLAZA, NEW YORK, NY, 10112, US

(21) Appl. No.: 10/547,794

(22) PCT Filed: Apr. 22, 2005
(86) PCT No.: PCT/JP05/08265

§ 371 Date: Sep. 6, 2005

(30) Foreign Application Priority Data
Apr. 28, 2004 (JP) 2004-132604

(51) Int. Cl. G01N 25/00; G01N 27/00

(52) U.S. Cl. 324/204; 374/45

(57) ABSTRACT

The present invention relates to a method in which a magnetic particle is used as a marker particle, a change in physical quantity corresponding to the number of magnetic particles is detected by applying a high-frequency magnetic field to the magnetic particle remaining due to a biochemical reaction and generating amount of heat, and a material contained in a sample solution is detected. A target material such as an antigen can be quantitatively detected with ease.

### TECHNICAL FIELD

The present invention relates to a detector and a detecting method and particularly relates to a detector and a detecting method which use the hysteresis loss of a magnetic particle.

### BACKGROUND ART

In immunization analysis, the following technique is mainly used. First, marker particles such as a phosphor material are diffused into a test sample. A secondary target material trap reacting only with a specific target material is coupled to the marker particle. The test sample is injected to a reaction field to which a primary target material trap reacting only with the target material is coupled. Then, in the presence of a desired target material, the marker particle is fixed to the reaction field via coupling between the target material and the secondary target material trap, unreacted marker particles are removed from the reaction field, and then the target material is detected. For example, this method includes radioimmunoassay (RIA) or immunoradiometric assay (IRMA) in which a competitive antigen or antibody is labeled with a radionuclide and an antigen is quantitatively measured from measurement results of the activity. An advantage of this method is a high sensitivity but a special facility or apparatus is necessary in view of the safety of radionuclides. As compared with radioimmunoassay, the enzyme-labeled antibody method (EIA) using an enzyme for modifying an antibody can be handled more easily and satisfies a practical sensitivity. However, it is necessary to further improve sensitivity and ease of handling.

The target material is a material handled in conventional immunoassay. For example, the target material is selected from the group consisting of an antibody, an antigen, protein, carbohydrate, lipid, nucleotider nucleic acid, and a cell. The target material trap is a material specifically coupled to the target material.

Japanese Patent Application Laid-Open No. S63-108264 discloses a magnetic immunoassay technique using a magnetic ultrafine particle.

However, higher sensitivity and more ease of handling are demanded in the above method. In the method of the application, a predetermined output waveform can be obtained by detecting the magnetization of magnetic ultrafine particles. However, the output waveform is obtained according to. the amount of magnetization of all magnetic ultrafine particles in a given region of a test sample. Thus, it is impossible to quantitatively treat, as digital data, the amount of an antigen or antibody in a specimen according to the detected waveform.

Therefore, in the currently used detecting method, quantitative detection cannot be made with ease. Detecting methods satisfying these needs are demanded.

### DISCLOSURE OF THE INVENTION

The present invention relates to a detecting method using the hysteresis loss of a magnetic particle. In view of the problem, a magnetic particle is used as a marker particle. For example, an alternating magnetic field is applied to magnetic particles which remain due to specific coupling such as a biochemical reaction and amount of heat is generated on the particles, so that a temperature change corresponding to the number of magnetic particles or a change in physical quantity due to the change is detected and quantitative detection can be made on a detected material such as an antigen.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a schematic diagram showing the cross section of a detection system used for a detecting method of the present invention in which laser light is launched into a prism and surface plasmon resonance is used;

FIG. 2 is a schematic diagram showing the cross section of the detection system used for the detecting method of the present invention in which laser light is launched into the prism and surface plasmon resonance is used;

FIG. 3 is a schematic diagram showing the cross section of a detection system used for the detecting method of the present invention in which laser light is launched into a diffraction grating and surface plasmon resonance is used;

FIG. 4 is a schematic diagram showing the cross section of a detection system used for the detecting method of the present invention in which a thermocouple is used;

FIG. 5 is a schematic diagram showing the positional relationship between parts, taken from the above of the detection system used for the detecting method of the present invention in which the thermocouple is used;

FIG. 6 is a schematic diagram showing the cross section of a detection system used for the detecting method of the present invention in which a thermistor is used;

FIG. 7 is a schematic diagram showing the cross section of a detection system used for the detecting method of the present invention in which an infrared radiometer is used;

FIG. 8 is a conceptual diagram showing that a primary antibody, an antigen, a secondary antibody and a magnetic particle are carried on a reaction field;

FIG. 9A is a schematic diagram showing the cross section of a detection system using a porous for a reaction region; and

FIG. 9B is an enlarged view of the porous reaction region.

The accompanying drawings, which are incorporated in and constitute apart of the specification, illustrate embodiments of the invention and, together with the description, serve to explain the principles of the invention.

### BEST MODE FOR CARRYING OUT THE INVENTION

The present invention relates to a method of detecting a sample in a sample solution by using a magnetic particle. The magnetic particle is heated by applying an alternating magnetic field to the magnetic particle, and a temperature change or a change in physical quantity due to the temperature change is detected on at least one of the magnetic particle or the peripheral area of the magnetic particle, so that the sample contained in the sample solution is detected. First, samples and magnetic particles are fixed by an antigen-antibody reaction or the like, and the magnetic particles are trapped according to the number of samples. Thereafter, the magnetic particles are heated by applying an alternating magnetic field to the magnetic particles, and a temperature change or a change in physical quantity due to the temperature change is detected. The change in physical quantity includes a change in index of refraction and a change in the magnetization of the magnetic particle. The change in physical quantity may be detected from the magnetic particle. When the magnetic particle is dispersed in a solution, a temperature change and a change in physical quantity due to the temperature change is detected in the solution, a container (channel) of the solution, and so on.

A conventionally used target material trap is applicable to the present invention. When the target material trap is fixed to a reaction field, a material which is readily coupled to the target material trap is chemically or physically carried on the inner wall of the reaction field. Thereafter, the target material trap can be injected and coupled to the reaction field. Various target material traps are available.

Similarly, various target material traps can act as a secondary target material trap to be fixed to a magnetic particle.

For example, the reaction field is a part of a channel where the sample solution flows. It is preferable that the reaction field be made of a material from which no heat is generated by the application of an alternating magnetic field. In order to prevent amount of heat generated from a magnetic particle from escaping, it is preferable that the reaction field be made of a material of low thermal conductivity or a heat shield be disposed around the reaction field.

For efficient heat generation, it is preferable that a magnetic particle used as a marker particle be made of a material of high hysteresis loss.

Any means can be used for a method of applying an alternating magnetic field to the magnetic particle. For example, a coil is disposed near or in the reaction field and an alternating current is applied to the coil. By filling the coil with a material such as an iron core of high magnetic permeability, a magnetic field can be generated more efficiently. Further, an alternating magnetic field can be applied to the magnetic particle also by causing a magnet to rotate on its axis or around the magnetic particle. When an alternating magnetic field is applied, generated amount of heat is kept in the reaction field, e.g., an inlet/outlet of a specimen in the reaction field is closed, so that quantitative detection can be made with higher-accuracy.

As a detecting method, an electrical detection is available which uses a thermocouple varied in electromotive force according to a temperature change, a thermistor varied in resistance value, and so on. A thermocouple and a thermistor available in the present invention can be used around room temperature. For example, the thermocouple is selected from the group consisting of chloroalumel-alumel, copper-constantan, chromel-constantan and platinrhodium-platinum. The thermomistor is an oxide of a transition metal selected from the group consisting of nickel-barium titanate, manganese, cobalt and iron. Further, a temperature change can be detected by an infrared radiometer. Moreover, optical detection can be made on surface plasmon resonance and a thermal lens using a change in the index of refraction of a solvent in the reaction field. The specific configurations of the present invention will be described in detail in the following embodiments.

### Embodiment 1

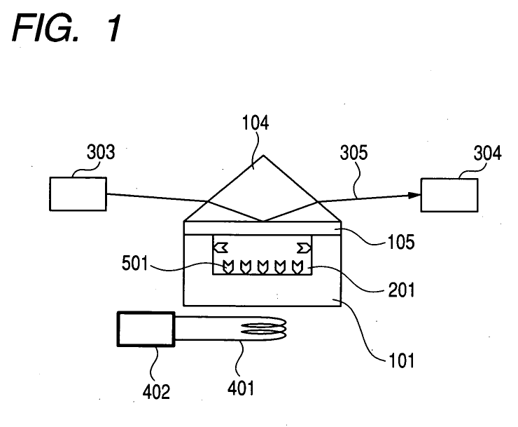

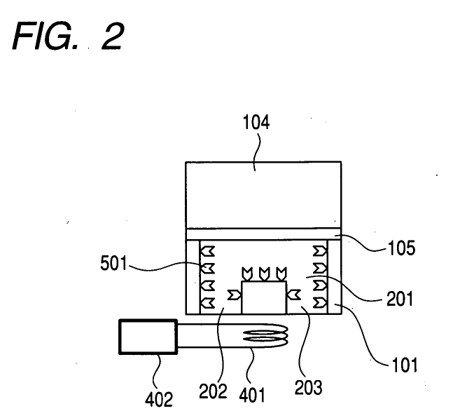

FIG. 1 is a schematic diagram showing the cross section of a detection system used for a detecting method of the present invention. FIG. 2 is a schematic diagram showing the cross section perpendicular to the cross section of FIG. 1. A channel 201 having a width of 100 μm and a depth of 40 μm is formed on a glass substrate, which serves as a casing 101, by a laser. An inlet 202 for injecting a specimen and an outlet 203 are formed on the ends of the channel 201. A prism 104 is disposed on the channel 201. A thin metal film 105 having a thickness of about 50 nm is deposited on a surface of the prism 104. A surface of the thin metal film 105 is surface treated with bovin serum albumin (BSA) to prevent the physical adsorption of protein in a specimen. In order to carry an antibody 501, hydrophilization is first performed on the inner wall of the channel 201 other than the surface of the thin metal film 105, and then the inner wall is treated with an amino-silane coupling agent. Further, by using a cross-linker such as glutaraldehyde for fixing a primary antibody 501, a peptide chain and an amino group derived from the amino-silane coupling agent are chemically bonded to each other to fix the primary antibody 501 for complementing a desired protein.

With this detector, a prostate-specific antigen (PSA) known as a marker of a prostate cancer can be detected according to the protocol below the primary antibody 501 for identifying a PSA is fixed on the inner wall of the channel.

(1) Phosphate buffered saline (sample solution) containing a PSA, which is an antigen (sample), is introduced into the channel and incubation is carried out for five minutes.

(2) An unreacted PSA is cleaned with phosphate buffered saline.

(3) An anti-PSA antibody (secondary antibody) solution labeled with a magnetite bead (magnetic particle) is introduced into the channel and incubation is carried out for five minutes.

(4) The unreacted and labeled antibody is cleaned with phosphate buffered saline and the channel is filled with the phosphate buffered saline.

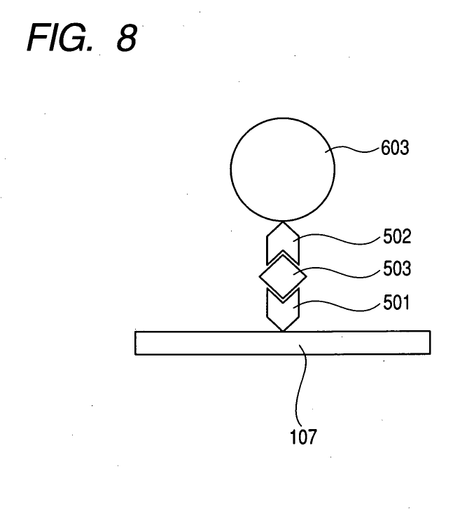

With this protocol, the magnetic particle is fixed to the reaction field via the primary antibody, the antigen and the secondary antibody. In this case, the average diameter of the magnetic particle is about 400 nm and superparamagnetism is observed. In FIG. 8, reference numeral 107 denotes the reaction field, reference numeral 501 denotes the primary antibody, reference numeral 502 denotes the secondary antibody, reference numeral 503 denotes the antigen, and reference numeral 603 denotes the magnetic particle. To be specific, when a sample solution contains a sample, the magnetic particle is trapped. When the sample solution contains no sample, the magnetic particle is not trapped in the reaction field.

Thereafter, laser light 305 is launched into the prism 104 and reflected light is measured by a photodetector 304. In a range including the angles of total reflection on the surface of the thin metal film 105, an incident angle is scanned by an automatic gonio stage having a high angle resolution while an angle between incident light and reflected light has a constant value all the time, and a reflectivity is measured. Then, a high-frequency current of 500 kHz is applied to a coil 401 by an alternating-current power supply 402, so that an alternating magnetic field is applied to the channel. Heat is generated on the magnetic particle by the alternating magnetic field and thus liquid in the channel 201 is heated. When a desired antigen is present in a specimen, the magnetic particle carried by the antigen-antibody reaction is heated and thus the liquid in the channel 201 changes its index of refraction and has a different reflectivity from that before the application of the magnetic field. Thus, an antigen in the specimen can be detected. For example, when the liquid is water, a decrease in plasmon resonance angle is confirmed by making measurements with SPR (surface plasmon resonance) of a Kretschmann configuration in which a gonio stage has an angular resolution of 0.0025°.

The angle change is converted into an index of refraction and further converted into a temperature change. The temperature change is converted into an antigen concentration according to a predetermined calibration curve, so that the antigen concentration of the PSA can be detected.

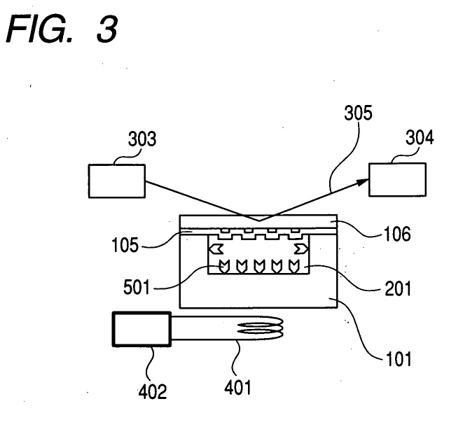

The present embodiment described the measuring method of surface plasmon resonance, in which the prism 104 is used. As shown in FIG. 3, instead of the prism 104, an uneven surface may be formed with, e.g., a pitch of 556 nm and a groove depth of 50 nm on a glass substrate, and a diffraction grating 106 may be used thereon. A thin metal film having a thickness of 50 nm is deposited on the diffraction grating 106.

Further, thermal conductivity is reduced by providing the casing 101 with a dual structure and producing a vacuum between two casings, thereby achieving detection with higher sensitivity.

### Embodiment 2

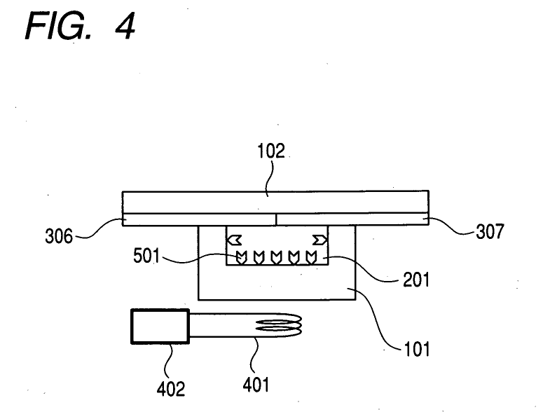

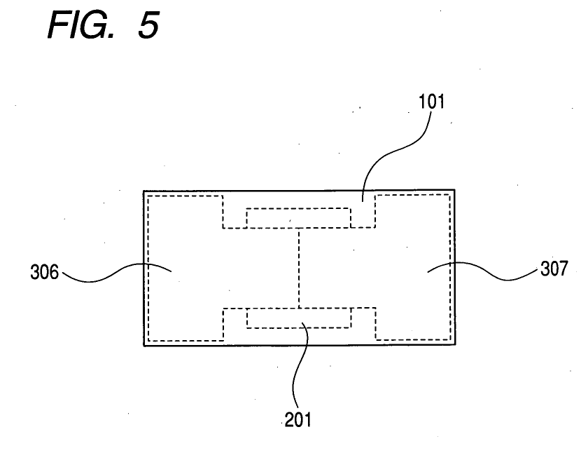

FIG. 4 is a schematic diagram showing the cross section of a sensing element for detecting an antigen according to the present embodiment. A casing 101 of the sensing element is made of ceramic. A channel 201 having a width of 100 μm and a depth of 40 μm is formed in the casing 101 by using a laser. Further, an inlet 202 for injecting a specimen and an outlet 203 are formed on the ends of the channel. A thermocouple composed of copper 306 and constantan 307 (alloy of 55% Cu and 45% Ni) is formed on the channel. The copper 306 and the constantan 307 are formed by vapor deposition. The junction of the copper 306 and the constantan 307 is disposed on the channel, and parts exposed from the casing 101 serve as electrodes connected to an external electric circuit. FIG. 5 is a schematic diagram showing the positional relationship, taken from the above of the device. Like Embodiment 1, for example, an anti-PSA antibody is fixed on the inner wall of the channel 201 by treatment using an amino-silane coupling agent in order to carry an antibody 501. Like Embodiment 1, a sample solution is introduced to the channel 201 and a PSA serving as a specimen is detected.

Thereafter, a high-frequency current of 500 kHz is applied to a coil 401 by an alternating-current power supply 402, and an alternating magnetic field is applied to the channel 201. A magnetic particle carried in the channel 201 by an antigen-antibody reaction is heated by the alternating magnetic field and thus the thermocouple is heated. At this point, the electrodes are both kept at a fiducial temperature of 0° C. The electrodes are respectively composed of the copper 306 and the constantan 307, protrude from the channel 201, and are formed on a lid 102 of the casing 101. Then, electromotive force is induced in the thermocouple according to a temperature difference from the junction of the copper 306 and the constantan 307. As the number of magnetic particles increases, a temperature increases in the channel 201. As the temperature increases, the thermocouple has higher electromotive force. Thus, the concentration of an antigen contained in the specimen can be detected by measuring the electromotive force.

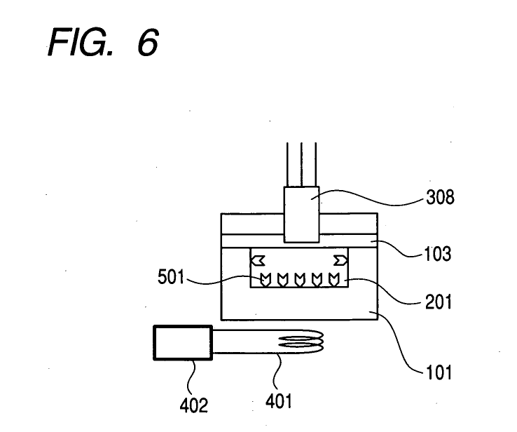

The present embodiment described the method of measuring a temperature in the channel 201 with the thermocouple. A thermistor 308 may be used to measure a temperature. FIG. 6 is a schematic diagram which shows the cross section of a measuring element when the thermistor 308 is used. The thermistor 308 is embedded into a lid 102 of a casing 101. A copper plate 103 is formed inside the lid 102 to transmit amount of heat in a channel 201 to the thermistor 308. Any material can be used as long as the copper plate 103 has a high thermal conductivity.

### Embodiment 3

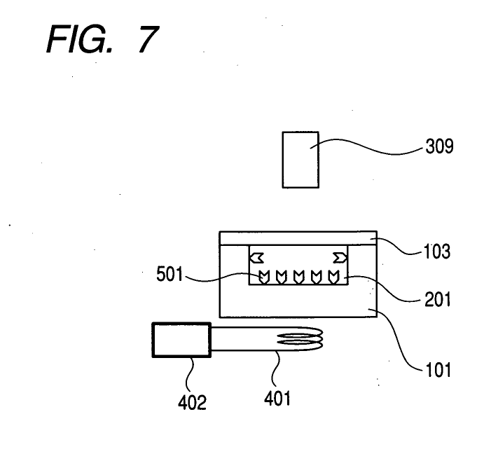

FIG. 7 is a sectional view which shows a sensing element to explain a detecting method and a detector of the present embodiment. A specimen concentration can be detected with a combination of a device, in which only a channel 201 is formed, and an infrared radiometer. Like Embodiment 1, glass having a low thermal conductivity is used for a casing 101. A lid composed of a copper plate 103 is formed on the casing 101 to transmit heat generated in the channel 201 to a surface of the device. Although the copper plate 103 is used in the present embodiment, any material may be used as long as the material has a high thermal conductivity and mechanical strength. The lid may be a structure made of two or more materials. Only a part irradiated with infrared rays is composed of a material having a high thermal conductivity and the other parts are composed of a material having a low thermal conductivity, so that thermal efficiency is increased and the sensing element can have higher sensitivity. According to the techniques of Embodiments 1 and 2, a primary antibody 501 is fixed and a PSA specimen is reacted. Thereafter, a high-frequency current of 500 kHz is applied to a coil and an alternating magnetic field is applied to the channel 201. A magnetic particle carried by an antigen-antibody reaction is heated by the alternating magnetic field and a temperature change is measured by the infrared radiometer disposed outside the device. At this point, in order to accurately measure the temperature of the device, it is necessary to determine an emissivity beforehand. A calibration curve of a change in measured temperature and a specimen concentration is produced, and then a specimen concentration is quantified.

### Embodiment 4

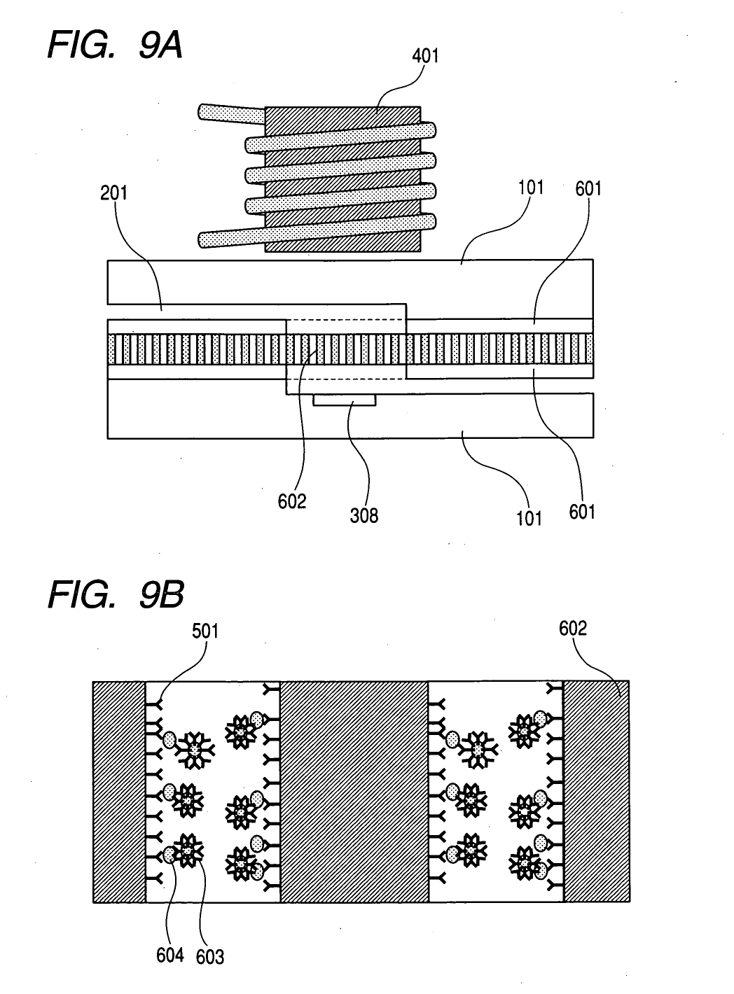

The present embodiment will describe an example in which a porous is used for a reaction region. In FIG. 9A, a membrane composed of a porous 602 is interposed between a casing 101 and a packing member 601. It is preferable that the casing 101 be made of a material having a low thermal conductivity. The porous 602 may be made of any material as long as a primary antibody 501 can be carried and no heat is generated by an alternating magnetic field. For example, silica or the like is used. Further, a thermistor 308 is disposed in the reaction region. FIG. 9B is an enlarged view showing the reaction field of the present embodiment. According to the techniques of Embodiments 1 and 2, the primary antibody 501 is fixed beforehand on the membrane composed of the porous 602. It is not always necessary to fix the primary antibodies 501 over the membrane. It is only necessary to fix the primary antibodies 501 in the reaction region equivalent to the opening of the packing member 601.

According to the methods of Embodiments 1 and 2, a PSA specimen in a specimen is reacted and a magnetic particle 603 is fixed via an antigen 604. Thereafter, a high-frequency current of 500 kHz is applied to a coil 401 by an alternating-current power supply 402, so that an alternating magnetic field is applied to a channel 201. The magnetic particle 603 carried in the channel 201 by an antigen-antibody reaction is heated by the high-frequency magnetic field. A temperature change caused by the heat generation is detected by a thermistor 308, so that the amount of antigen in the specimen is quantified.

The detecting method and the detection device of the present invention described in these embodiments are used particularly for a method of detecting a biological material. In this method, a magnetic particle is used as a marker particle, a change in physical quantity corresponding to the number of magnetic particles is detected, and a material contained in a sample solution is detected. A target material such as an antigen can be quantitatively detected with ease.

This application claims priority from Japanese Patent Application No. 2004-132604 filed Apr. 28, 2004, which is hereby incorporated by reference herein.

1. A method of detecting a sample in a sample solution by using a magnetic particle, characterized in that the magnetic particle is heated by applying an alternating magnetic field to the magnetic particle, and a temperature change or a change in physical quantity due to the temperature change is detected on at least one of the magnetic particle or a peripheral area of the magnetic particle, to detect the sample contained in the sample solution.

2. The detecting method according to claim 1, characterized in that the method further comprises:
a step of disposing a first material in a predetermined region,
a step of injecting the sample solution containing the magnetic particle into the region having the first material, the magnetic particle having a second material formed on a surface, and
a step of removing the magnetic particle not directly or indirectly fixed to the first material.

3. A detector, comprising:
a casing,
a channel which is formed in the casing and has a first material, and
means of applying an alternating magnetic field to the channel,
the detector detecting a sample in a solution containing a magnetic particle,
characterized in that the detector further comprises means of detecting a temperature change or a change in physical quantity due to the temperature change on at least one of the magnetic particle or a peripheral area of the magnetic particle, the temperature change occurring upon application of the alternating magnetic field.

4. The detector according to claim 3, characterized in that a porous is disposed in the channel and the first material is fixed to the porous.
